(19) United States
(12) Patent Application Publication
(10) Pub. No.: US 2015/0148271 A1
(43) Pub. Date: May 28, 2015

(54) SLIDING LAYER AND SLIDING ELEMENT PROVIDED WITH SAID TYPE OF SLIDING LAYER

(71) Applicant: Federal-Mogul Deva GmbH, Stadtallendorf (DE)

(72) Inventors: Hannes Golob, Mondsee (AT); Thomas Walter, Marburg (DE); Dorit Pitz, Stadtallendof (DE); Martin Muller-Brodmann, Weimar (DE); Martin Pitz, Stadtallendorf (DE); Achim Schmidt, Ebsdorfergrund (DE)

(21) Appl. No.: 14/406,416

(22) PCT Filed: Jun. 5, 2013
(86) PCT No.: PCT/EP2013/061536

§ 371 Date: Dec. 8, 2014

(30) Foreign Application Priority Data
Jun. 6, 2012 (DE) 10 2012 209 592.6

(51) Int. Cl. C10M 169/04; F16C 33/20; F16C 33/16; F16C 33/28

(52) U.S. Cl. CPC C10M 169/04; F16C 33/28; F16C 33/201; F16C 33/16
USPC 508/106; 508/109

(57) ABSTRACT

The invention relates to a sliding layer based on a fiber-reinforced plastic, having a plastic matrix and at least one plastic thread as a reinforcement element. Said plastic matrix comprises at least one metal soap, preferably based on lithium stearate. No stick-slip effect occurs when using said sliding elements comprising said type of sliding layers, with steel counter elements.

The invention relates to a sliding layer based on a fiber-reinforced plastic in accordance with the preamble to patent claim 1. It further relates to a sliding element having such a sliding layer and to the use of the sliding element.

As a rule, plain bearing elements comprise a bearing layer and a sliding layer. The sliding layer is produced based on a fiber-reinforced plastic with a plastic matrix and plastic threads as a reinforcement material, wherein the plastic threads may have filaments. Such sliding layers and sliding elements are known for instance from DE 10 2006 043 065 B3.

Wind turbines in which the rotational axis of the rotor is essentially horizontal (horizontal rotor type) have a nacelle borne on a tower.

The nacelle bearing may be embodied as a ball bearing slewing ring or as a sliding rotary connection. In either case, the relative movement occurs between a toothed tower-fixed bearing ring and a bearing ring on the base plate of the support. Mounted fixed on the support are a plurality of drive motors with a reduction gear that each engages with the teeth of the tower-fixed bearing ring via a driveshaft a pinion. This system is called a yaw system.

In known wind turbines, as a rule in the case of a ball bearing slewing ring the turbulence-created torque about the tower axis of rotation is absorbed by separate brakes. When using a plain bearing (sliding rotary connection), as is described for instance in U.S. Pat. No. 6,814,493, a significant portion of the forces that occur during operation may be compensated by the friction of the anti-friction linings, if these have a suitable coefficient of friction. As a rule, both types of yaw systems have drive motors in which an additional brake is provided for covering even more of the operating torque and possibly extreme loads occurring on the drive side.

During operation of wind turbines, the nacelle is rotated by a pre-determined angular about the vertical by a corresponding drive and held fast there, in the context of controlling the system for optimum inflow towards the rotor.

In this type of operation, squeaking or chattering noises can occur that are radiated via the resonance body, the tower, so that they are audible for a long distance, and that are introduced into the ground via the foundation.

The squeaking and chattering noises are caused by the so-called stick-slip. It has been determined that the vibration occurs in the sliding contact between the slideway lining and the tower fixed sliding ring, which consists of steel. However, the vibrating itself or the vibration frequency and intensity are determined by the entire system (resonator with individual masses and spring constants).

It is believed that a minimum energy must be introduced into the resonator to produce these squeaking or chattering noises.

There have been attempts to prevent this minimum energy from being introduced into the resonator in that measures have been taken to absorb this energy at its inception point, i.e. on the plain bearing element or in the immediate vicinity of the plain bearing element.

One approach to solving the problem involved limited movement of the plain bearing element and providing at least one positive dissipation element between the plain bearing element and the bearing housing, so that this energy is absorbed early on to prevent the squeaking noises.

Such measures are complex and expensive, and it was not always possible to completely and reliably prevent the squeaking noises.

The object of the invention is to prevent the occurrence of stick-slip movements and thus the occurrence of squeaking and chattering noises in sliding layers and sliding elements, especially in the use of wind turbines.

This object is attained with the features of claim 1.

By adding at least one metal soap as a component of the plastic matrix of the sliding layer, the stick-slip movement and thus the squeaking and chattering noises may be largely suppressed, especially when using steel counter elements.

It is believed that the cause of the squeaking and chattering noises and of the occurrence of the stick-slip movement is that during the course of operation, impurities find their way between the sliding element and the counter element. The primary cause is believed to be leaked oil that escapes in small quantities from the hydraulic systems, e.g. control and brake systems, and some of which may also get to the sliding connections. In addition, the possibility cannot be ruled out that during maintenance work, e.g. on the nacelle drive, lubricant is inadvertently permitted to come into contact with the sliding connection or that residual anti-corrosion agents (wax or oil) were not sufficiently removed after the steel sliding ring was assembled.

Tests with such hydraulic oils and lubricants used e.g. in wind turbines for lubricating e.g. the teeth of the nacelle drive have demonstrated that sliding elements contaminated therewith and that contain these metal soaps do not exhibit the undesired stick-slip effect.

Metal soaps are known per se. They include all metal salts of the fatty acids with the exception of sodium and potassium salts. Usual metal soaps are salts of aluminum, barium, cadmium, lithium, calcium, magnesium, zinc, lead, manganese, copper, and cobalt. An overview of the variety of purposes for which the various metal salts are employed may be found in Ullmann's Encyklop\vec{a}die der technischen Chemie [Encyclopedia of Technical Chemistry], “Schwefel bis Sprengstoffe” [Sulfur through Explosives], 4th edition, volume 21, pages 224, 225].

The matrix material includes graphite at a portion of 10 to 20 wt. % relative to the plastic matrix. It has been found that the addition of graphite without the addition of metal soap has not demonstrated any adequately positive effects with respect to the stick-slip effect. Conversely, it has been found that adding metal soap, while not using graphite, effectively reduces or even prevents the slip-stick effect. However, the positive effect of the transfer film build-up, which is typical of graphite and which may support the effect of the metal soap, is lacking.

Due to a possibly synergistic effect, the combination of graphite and metal soap has an advantageous effect in that the stick-slip effect was not observed in any of the investigated cases. Equal portions of graphite and metal soap, especially lithium stearate, with a fluctuation range of ±2 wt. %, are particularly preferred. This applies preferably for portions in the range of 10 to 20 wt. % for the lithium stearate.

The portion of plastic matrix on the sliding layer is 40 wt. % to 80 wt. %. Thus the portion of the plastic thread on the sliding layer is 20 wt. % to 60 wt. %.

The metal soap is preferably selected from the group of aluminum stearate, barium stearate, calcium stearate, chromium stearate, lithium stearate, magnesium stearate, tin stearate, and zinc stearate. Particularly preferred is lithium stearate (C₁₈H₃₅LiO₂). Lithium stearate is considered the highest quality metal soap when used as a thickener for technical fats. The advantage of the lithium stearate is its resistance to water, its broad application temperature range, and its pressure resistance.

To completely prevent the stick-slip effect, a minimum quantity of metal soaps is required and is preferably 7.5 wt. % relative to the matrix material.

The maximum quantity is preferably limited to approx. 30 wt. %, because otherwise the strength of the sliding layer, which is determined by the matrix material, decreases excessively. A matrix portion of the entire sliding layer is based on at least 40 wt. %. A preferred range is 40 wt. % to 80 wt. %, especially 60 wt. % to 80 wt. %.

The matrix material preferably has epoxide resin that is preferably the principle component. As the principle component, the epoxide resin forms the largest portion of the entire matrix material. The portion of the epoxide resin is preferably ≧35 wt. %. Epoxide resin comprises polymers that, depending on how the reaction is conducted, with the addition of a suitable curing agent provide a thermosetting plastic with high strength and chemical resistance. If epoxide resin and curing agents are mixed, normally the mixture cures within a few minutes to a few hours, depending on composition and temperature.

Like all polyethers, epoxide resins are either represented by catalytic polymerization of epoxides (oxiranes) or by the conversion of epoxides, e.g. epichlorohydrin with dioles, e.g. bisphenol A. The addition of a monovalent alcohol stops the polymerization.

For processing, both in the manufacture of sliding layers in the winding process and for impregnating polymer fabrics (so-called prepreg technique), epoxide resins must lie within a certain viscosity range so that, on the one hand, sufficient wetting of the polymer threads is attained and on the other hand processing is economical. Adding metal soaps increases the viscosity of the resin mixture addressed above.

In order to be able to use the epoxide resin mixture that forms the matrix material at room temperature, a portion of metal soaps of a maximum of 20 wt. % is preferred. A preferred range is 10 to 18 wt. %.

The sliding layer based on a fiber-reinforced plastic preferably has a plastic thread as a reinforcement element that has at least one thermoplastic plastic. Preferred possible thermoplastic plastics are polyesters and polyethylenes. In addition to polyester, the plastic threads may also include PTFE filaments or the PTFE may be added to the plastic matrix described in the foregoing as a powder.

The sliding layer may be easily proceesed mechanically, i.e. by machining. The use of the plastic thread with PTFE particles in the sliding layer is therefore suitable in particular for precision plain bearings that must be finished to the final dimensions by machining, for instance.

It is advantageous when the weight portion of the PTFE particles in the plastic threads is between 2 wt. % and 40 wt. % and the weight portion of the polyester filaments in the plastic threads is between 60 wt. % and 98 wt. %. It is particularly preferred when the weight portion of the PTFE particles in the plastic threads is between 30 wt. % and 36 wt. %, while the weight portion of the polyester filaments in the plastic threads is between 64 wt. % and 70 wt. %.

With this weight ratio, the adhesion between the plastic thread and the plastic matrix remains adequately high so that good machinability is attained. On the other hand, the portion of the PTFE particles is sufficiently high to attain a good sliding property.

In one advantageous embodiment of the sliding layer, the reinforcement element has the structure of a woven or knit fabric produced from the plastic threads. In accordance with another preferred embodiment, the reinforcement element has a winding structure that is produced by winding the plastic thread onto a winding core.

The advantages of the plastic thread used are particularly well evident. Specifically, due to its roughness, it is extremely well suited to the production of sliding layers in the winding process in which the thread is first guided through an impregnation bath with the plastic resin, especially epoxide resin, containing the metal soap and graphite, and is thus sufficiently impregnated by the bath material. The winding method offers the advantage that in this way a certain winding structure may be produced that is matched to the intended application of the sliding element or the sliding layer. Thus the fibers may be positioned in the fiber composite in the most appropriate way for the stress, i.e. according to the force and tension distribution.

For many applications, in addition to the PTFE particles spun into the plastic threads, PTFE particles are also preferably added to the plastic matrix. The portion of PTFE particles in the plastic matrix is at most 40 wt. %.

Furthermore, both PTFE particles and graphite particles may be added to the plastic matrix having the metal soap, wherein the total weight portion of the particles is preferably no more than 40 wt. %.

The inventive sliding elements has a sliding layer as was described in the foregoing.

In the case of thin-walled sliding elements, it is possible for these to consist of merely one sliding layer, preferably a single-layer sliding layer. Although its mechanical loadability is not very high, in cases of low loading this design may be preferred for reasons of costs and space.

The sliding element preferably has a bearing layer on which at least the sliding layer is disposed. In this embodiment the loadability is greater. The sliding element preferably has a bearing layer comprising a fiber-reinforced plastic.

In one advantageous embodiment, the fiber-reinforced plastic of the bearing layer likewise comprises a plastic matrix having a glass fiber as reinforcement element, wherein the plastic matrix preferably comprises a plastic resin, particularly preferred epoxide resin.

As also for the plastic matrix of the sliding layer, epoxide resin is also suitable as plastic matrix for the bearing layer due to excellent adhesion properties and good mechanical and dynamic properties. Due to its molecular structure, epoxide resin furthermore has a very good moisture resistance and a comparatively low tendency to swell. Due to the use of the same plastic matrix in the sliding layer and in the bearing layer, in addition the binding forces between the sliding layer and the bearing layer increase.

Since the bearing layer does not have any contact with a sliding partner, as is the case for the sliding layer, the plastic matrix is preferably free of metal soap and/or graphite.

Also the reinforcement element of the bearing layer preferably has the structure of a woven or knit fabric produced from the glass fiber or in another preferred embodiment has a winding structure that is produced by winding the glass fiber onto a winding mandrel.

If the sliding layer and the bearing layer are placed on a winding mandrel one after the other in the winding process, this increases the efficiency of the production of the bearing composite material.

The sliding element is preferably used for bearing wind turbine nacelles. Additional features and advantages of the invention are explained in the following using exemplary embodiments.

The only FIGURE is a perspective drawing of an inventive sliding element in the form of a radial plain bearing.

The application example depicts a sliding element, in this case a radial plain bearing bush 20 in accordance with the FIGURE. It has on its interior side a sliding layer 22 and on its exterior side a bearing layer 24. The sliding layer 22 is embodied radially thinner than the bearing layer 24.

Both layers 22, 24 were placed one after the other in the winding process on a winding mandrel, creating the winding structure 23 and 25 depicted by the cross-hatching. It may also be seen that the distance between the threads in the winding structure 25 of the bearing layer 24 is greater than that in the winding structure 23 of the sliding layer 22. This is intended to indicate that the structures may be adapted individually to different requirements. For rotationally symmetrical sliding elements, the winding represents a particularly simple and cost-effective production method, wherein the winding structures 23 and 25 of the reinforcement elements of the sliding layer 22 and also of the bearing layer 24 may be adapted to the mechanical requirements of the bearing in a simple manner. In addition to the depicted simple cross structures, the threads may be wound not only individually but rather also for instance grouped into bundles, so that preferably the reinforcement element of the bearing layer may be grouped with a cross structure on a thread or fiber bundle wound on a winding mandrel.

The sliding layer may have dirt grooves 26 on the inwardly facing side, which may be worked into the sliding layer after the finished wound body has cured and the bearing bush has been separated by stripping, boring, turning, or the like.

Different reinforcement elements are used in the sliding layer 22 and in the bearing layer 24; specifically, on the one hand plastic threads are used in the sliding layer and on the other hand glass fibers are used in the bearing layer 24. The principle component of the plastic matrix is preferably the same in both layers, specifically epoxide resin. It is very well suited based on its excellent adhesion properties, mechanical properties, and not least due to its comparatively low price. Alternatively, however, unsaturated polyester resins or vinyl ester resins may be used, for instance.

In addition to the proven glass fibers, for instance carbon fibers may be used for the reinforcement element for the bearing layer 24. The threads may also first be pre-processed to create a woven fabric, knit fabric, or other fabric.

The plastic matrix of the sliding layer 22 includes at least one metal soap, in particular lithium stearate, having a portion of 7.5 to 30 wt. %. Solid lubricants such as for instance graphite particles or PTFE particles may be added in. In contrast, as a rule the bearing layer 24 has a plastic matrix without the addition of other components.

In addition to the radial plain bearing depicted in the FIGURE, the inventive sliding element may furthermore take the form of a collar bearing, thrust washer, floating bearing or fixed bearing, bearing shell, or sliding plate. Various laminating methods may also be used for the production. For instance, in the so-called prepreg process, pre-impregnated reinforcement elements in the form of a woven fabric, knit fabric, or other fabric may be joined in a subsequent pressing or autoclaving process to create the finished sliding elements. However, the finished sliding elements may also be produced using the injection mold method, in which pre-fabricated mats are placed into a mold that is then filled under pressure with the plastic resin. The pre-processed woven fabric, knit fabric, or other fabric may also be further processed in the winding process.

### EXAMPLE 1

### Inventive Example

Plastic resin matrix:

Epoxide resin: 38 wt. % Epikote 827®

Curing agent: 34 wt. % Epikure MNA®

Activator: 1.74 wt. % DMP300 activator

Additive: 0.26 wt. % BYK A525® additive

(Brands from Momentive Specialty Chemicals, 180 East Broad Street, Columbus, Ohio 43215, USA)

| | |
|---|---|
| Graphite | 13 wt. % |
| Lithium stearate | 13 wt. % |

The plastic matrix portion of the sliding layer material is 74 wt. %.

Plastic threads: Polyester

The plastic thread portion of the sliding layer material is 26 wt. %.

Using a square mandrel, plates were made from this sliding layer material in the winding process, and from these plates circular disks (so-called pads) having a diameter of 80 mm were produced by first using waterjet cutting and then using subsequent turning operation. These pads are standard test parts for all typical surface/surface tests for sliding elements in wind turbines for the yaw system.

The bearing layer comprises a glass fiber/epoxide resin compound.

The testing apparatus functions as follows:

The testing body (pad), having a nominal diameter of 80 mm, is fixed in a holder having a complementary shape. A steel plate with a surface roughness of Rₐ 0.5 . . . 0.8 μm and having a hardness of >45 HRC acts as counter surface. HRC is the Rockwell hardness. This steel plate is also placed in a holder and is moved linearly by means of a hydraulic cylinder at a mean sliding speed of v=0.01 ms. The movement is translatory and has a stroke length of +/−80 mm. The selected mean surface pressure is aligned to the pressure of 20 MPa, that is typical for sliding rotary connections. It is produced in that a second hydraulic cylinder exerts a constant, previously calculated and adjusted force onto the back side of the steel testing plate retaining device via a lever system and a roller-borne steel roller. The ambient temperature during the tests is 19° to 21° C.

In order to provoke the occurrence of stick-slip effects, after approx. 10 stroke movements the surface of the steel plate that is exposed at the stroke maximum is sprayed with a commercially available penetrating oil (300 ml spray can) called “Multigliss®”. Multigliss® is a Dow Corning product and, due to its extremely good wetting properties (low surface energy), produces the undesired slip-stick very intensively and rapidly due to undesired adhesion effects between the sliding components.

### EXAMPLE 2

As in Example 1, but without graphite. The wt. % portions were correspondingly adapted in the same ratios.

### EXAMPLE 3

### Comparison Example

For comparison purposes, sliding elements were produced with a plastic matrix that had the same composition as the inventive composition, but did not include any lithium stearate. The wt. % portions are adapted in the same ratio.

The plastic threads likewise comprise polyester.

It was checked whether the stick-slip effect occurred. The number of test movements (strokes) until the first perceivable occurrence of stick-slip may be used as the stick-slip parameter.

It was found that in Examples 1 and 2 no stick-slip effect occurred, even after 450 strokes. In comparison example 3, in 10 tests the stick-slip occurred after 6 to 12 strokes.

### REFERENCE NUMBERS

20 Radial plain bearing
22 Sliding layer
23 Winding structure (of 22)
24 Bearing layer
25 Winding structure (of 24)
26 Dirt groove

1. A sliding layer based on a fiber-reinforced plastic
having a plastic matrix and
having at least one plastic thread as a reinforcement element,
and wherein
the plastic matrix has graphite and at least one metal soap, wherein the portion of the graphite in the plastic matrix is 10 to 20 wt. %, relative to the plastic matrix, and the portion of the plastic matrix in the sliding layer is 40 wt. % to 80 wt. %.

2. The sliding layer in accordance with claim 1,
wherein the portion of the metal soap in the plastic matrix is 7.5 wt. % to 30 wt. %.

3. The sliding layer in accordance with claim 1,
wherein the metal soap is selected from the group of aluminum stearate, barium stearate, calcium stearate, chromium stearate, lithium stearate, magnesium stearate, tin stearate, and zinc stearate.

4. The sliding layer in accordance with any claim 1,
wherein the plastic matrix has epoxide resin.

5. The sliding layer in accordance with claim 1,
wherein the plastic matrix has PTFE particles.

6. The sliding layer in accordance with claim 1,
wherein the plastic thread has at least one thermoplastic plastic.

7. The sliding layer in accordance with claim 6,
wherein the thermoplastic plastic is polyester or polyethylene.

8. The sliding layer in accordance with claim 1
wherein the reinforcement element has the structure of a woven or knit fabric produced from a plastic thread.

9. The sliding layer in accordance with claim 1,
wherein the reinforcement element has a winding structure that is produced by winding the plastic thread on a winding core.

10. A sliding element having a sliding layer based on a fiber-reinforced plastic
having a plastic matrix and
having at least one plastic thread as a reinforcement element, and wherein the plastic matrix has graphite and at least one metal soap, wherein the portion of the graphite in the plastic matrix is 10 to 20 wt. %, relative to the plastic matrix, and the portion of the plastic matrix in the sliding layer is 40 wt. % to 80 wt. %.

11. A sliding element in accordance with claim 10,
including a bearing layer made of a fiber-reinforced plastic.

12. (canceled)
